(19) United States
(12) Patent Application Publication
(10) Pub. No.: US 2018/0124782 A1
(43) Pub. Date: May 3, 2018

(54) Method for Allocating Time Slots

(71) Applicant: Wiesemann & Theis GmbH, Wuppertal (DE)

(72) Inventor: Simon Lindhorst, Wermelskirchen (DE)

(21) Appl. No.: 15/567,996

(22) PCT Filed: Jan. 22, 2016
(86) PCT No.: PCT/DE2016/100025

§ 371 Date: Oct. 20, 2017

(30) Foreign Application Priority Data
Apr. 22, 2015 (DE) 10 2015 106 205.4

(51) Int. Cl. H04W 72/04

(52) U.S. Cl. CPC H04W 72/0446

(57) ABSTRACT

The invention relates to a method for transmitting data packets in a wireless interconnected network having a plurality of nodes, wherein a fixed time slot having an ordinal number is assigned to each communication relation between the nodes and the communication relations are performed in the order of said ordinal numbers. A corresponding time slot in which transmitter and receiver are exchanged is assigned to each time slot. The corresponding time slot is assigned in accordance with the stipulation that the next higher ordinal number for the corresponding time slot is assigned to the next lower ordinal number for a time slot.

The invention relates to a method for transmitting data packets in a wireless interconnected network having a plurality of nodes, wherein a fixed time slot with an ordinal number is assigned to each communication relation between the nodes and the communication relations are performed in the order of the said ordinal numbers.

In addition, the invention relates to a wireless interconnected network having a plurality of nodes for transmitting data packets wherein a fixed time slot with an ordinal number is assigned to each communication relation node and the communication relations are performed in the order of the said ordinal numbers.

In the case of interconnected or mesh wireless networks as well, network nodes are used not only as end points, e.g. as measurement transducers, but also to be able to forward or route the data of other nodes. In this way the network's range is extended beyond the wireless range of the individual node. Such solutions are familiar for example, from DE 10 2009 052 573 or DE 10 2010 033 928. When a network of this type is put into operation, each communication relation is given a fixed time slot within a higher level time slot period. With wireless communication in interconnected networks, there is always only a single combination at one time. With previously known solutions, assignment of the time slots during the self-controlled start-up of the network takes place taking account of time delays at an unsatisfactory speed and with insufficient utilisation of the network geometry.

The present invention thus meets the challenge of creating a method to transmit data packets in an interconnected network and a network that enables processing of the communication relations in a particularly effective and therefore time-saving manner.

In line with the procedure, this task is solved by having a corresponding time slot allocated to each time slot in which transmitter and receiver are exchanged, whereby the assignment of the corresponding time slot is carried out in accordance with the provision that in each case the next high ordinal number for the corresponding time slot is allocated to the next low ordinal number for a time slot.

It is important to process the many combinations that are conceivable in such a network consecutively in an effective manner in a given and particularly expedient succession at exactly stipulated times. Each time slot is allocated a corresponding or parallel time slot in which transmitter and receiver are exchanged. The time slot and the corresponding time slot are then coordinated with each other in such a way that in each case the highest ordinal number for a corresponding time slot is allocated to the respective lowest ordinal number. Thanks to this numbering in accordance with the invention, all communication steps can be processed in a single cycle. The switching sequence in accordance with the invention ensures here that the first communication relation on the route from the master in the direction of the slave nodes corresponds to the last on the return path and that in between as it were mirrored pairs are formed. A higher parallel time slot is allocated to the lower time slot, a comparably lower parallel time slot is allocated to a higher time slot. The sequence of the individual data packets corresponds exactly to the numbering, whereby the pairs consisting of a time slot and a corresponding time slot are coordinated with each other in an advantageous manner so that the geometry of the network is taken into account or utilised optimally.

It is in the nature of interconnected wireless networks that communication always takes place from node to node, for example nodes cannot be left out. The order results hereby in that a communication relation that was allocated the smallest possible ordinal number on the way from the master to the slave nodes is given the highest possible ordinal number on the return. In contrast, assignment to a parallel time slot with a comparably low ordinal number is aimed for in the case of communication relations with high ordinal numbers on the outbound direction. This stipulation leads to fast and undisturbed communication in both directions. With this in mind, it is suggested that the assignment of time slot and corresponding time slot is carried out using the equation

Ordinal number of the corresponding time slot=Number of time slots per time slot period+1−Ordinal number for the time slot

It is recommended that the assignment of the time slots is carried out in the framework of the step-by-step self-controlled start-up of the network. The numbering is assigned on the structuring of the network, as soon as a new node was detected by the other participants.

Another advantageous embodiment of the invention provides that when the network starts up, assignment of the time slots is carried out in dependence on the distance to the respective master node. This is insofar important as the distance to the respective master node, or the number and arrangement of the other slave nodes between the slave node concerned and the master node, is of essential importance for the numbering of the nodes and thus for the stipulation of the processing of the communication relations.

Specifically, when the network is started up, in a first step time slots are assigned to slave nodes that communicate directly with the master node. Consequently, the slave nodes that are closest to the master node are given the lowest ordinal numbers, so that they are processed first of all on transmission from the master node into the network. However, with regard to the specification of speed reduction, it is much more important that, when the numbering is assigned in the direction of the master keys, communication relations in direct proximity to the master node have the highest ordinal numbers, so that these data connections are processed as the last in the framework of the cycle after the intermediate nodes have been passed through.

It is planned in supplement to this that when the network is started up, time slots are assigned in further steps to the slave nodes that communicate with the master node through additional slave nodes. The more slave nodes there are between the master and the new node, the greater is the distance between the new node and the master node. Insofar, that the numbering of the communication relations on the route away from the master node is higher with an increasing distance from the master node, while on the return, seen from the master node, the communication relations that are further away are numbered first, until the last connection on the return, namely the slave nodes located in direct proximity to the master node and the master node itself are numbered. Starting from a master node, therefore, first of all the nodes close to the master node are detected and numbered, and the nodes that are further away after this. The actual distribution of numbers therefore results both from the sequence of detection and from the algorithm of the number generator.

The task in accordance with the invention is solved with regard to the network in that each time slot is assigned a corresponding time slot in which transmitter and receiver are exchanged, whereby the assignment of the corresponding time slot is carried out in accordance with the principle that in each case the next higher ordinal number for the corresponding time slot is assigned to the lowest ordinal number for a time slot.

The assignment of time slots leads to a data packet ideally requiring only a single time slot period that corresponds to the throughput of all individual time slots, in order to reach its destination, regardless of the direction in which the data flow takes place. What is significant for this process is that, in particular, transmission in the direction of the master is much faster on the return than was the case with the state of the art.

The invention is characterised in particular in that a method of transmitting data packets and an interconnected network are created that enable significant optimisation of the time distribution in a network of this type. The geometry of a mesh network is utilised optimally. In accordance with the method, each time slot is assigned a corresponding or parallel time slot with an exchanged transmitter/receiver relation. The result of these pairs for each communication relation between the nodes is that the next higher ordinal number for the corresponding or parallel time slot is assigned to the next lower ordinal number for a time slot. This numbering is advantageous in that all communication steps can be processed in a single cycle, whereby the actual distribution of the numbers results from the sequence in which the nodes are detected and the algorithm of the number generator. Otherwise, with exchanged numbering there is a wait until the next cycle before communication can be continued. If several of the numbers are exchanged at the same time, and if even more intermediate stations are participating, there would be an even greater increase in lost time.

Further details and advantages of the object of the invention can be seen in the following description of the associated drawing, in which a preferred embodiment is shown with the required details and parts.

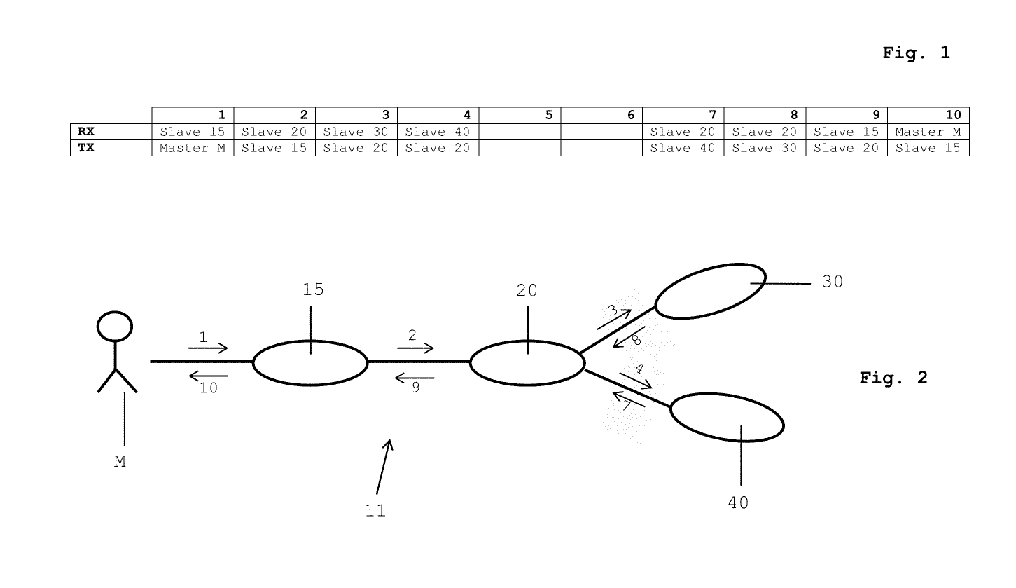

FIG. 1 shows a tabular list of the numbering and

FIG. 2 shows a functional diagram.

FIG. 1 refers to the tabular reproduction of the numbering for the individual communication relations. In this example, the top line corresponds to 10 time slots of 10 ms per time slot period. The second line, marked RX, shows the nodes with regard to the communication relations on the way from the master node in the direction of the network, and in the bottom line for the return from the network or from the slave nodes to the master node. The master nodes are marked M and the slave nodes are marked with the reference signs 10-40. Pairs are formed in the table in FIG. 1 on the basis of the algorithm in accordance with the invention from the outside to the inside, i.e. with reference to the ordinal numbers the pairs 1 and 10, 2 and 9, 3 and 8, and 4 and 7. Each time slot is therefore firmly coupled with a corresponding time slot, and for this there must be an even number of time slots.

To explain the equation in accordance with the contract by means of this example: let n be the number of these time slots for this time slot period, in this case therefore n=10. The time slot belonging to the time slot i results from n−i+1. If therefore n=1, the corresponding time slot to the second time slot is 10−2+1, i.e. the ninth time slot shown in the table in FIG. 1.

For this purpose, FIG. 2 shows a functional diagram. Starting from the master node M, numbering takes place to the slave nodes 10, 20, 30, 40. The data network 11 comprises communication relations that are assigned the reference signs 1-4 and 7-10. The communication relations 1 for the outgoing and 10 for the return path are formed in pairs in the section positioned most closely to the master M. Because of the proximity to the master node M, this numbering is carried out first when the network is developed. It joins the connection between the two slave nodes 10 and 20 with the communication relations 2 and 9, which are numbered in a second step, because there is no direct contact between master M and slave node 20. Finally, slave nodes 20 and 30 are in contact through the communication relations 3 and 8, and slave nodes 20 and 40 through the communication relations 4 and 7. With reference to FIG. 2, this numbering is done last of all, because the distance from the master node M is the greatest.

1. Method for transmitting data packets in a wireless interconnected network having a plurality of nodes, wherein a fixed time slot with an ordinal number is assigned to each communication relation between the nodes and the communication relations are performed in the order of the said ordinal numbers,
characterised in that
each time slot is assigned a corresponding time slot in which transmitter and receiver are exchanged, whereby the corresponding time slot is assigned in accordance with the stipulation that the next higher ordinal number for the corresponding time slot is assigned to the next lower time slot.

2. Method in accordance with claim 1,
characterised in that
that assignment of the time slots and corresponding time slots is carried out in accordance with the equation
Ordinal number of the corresponding time slot=Number of time slots per time slot period+1−Ordinal number for the time slot

3. Method in accordance with claim 1,
characterised in that
assignment of the time slots is carried out in the framework of the step-by-step self-controlled start-up of the network.

4. Method in accordance with claim 3,
characterised in that
when the network starts up assignment of the time slots is carried out in dependence on the distance to the respective master node,

5. Method in accordance with claim 4,
characterised in that
when the network starts up in a first step time slots are assigned to the slave nodes communicating with the master node.

6. Method in accordance with claim 4,
characterised in that
when the network starts up in further steps time slots are assigned to the slave nodes communicating with the master node through other slave nodes.

7. Wireless interconnected network (11) having a plurality of nodes (10, 20, 30, 40) for transmitting data packets, wherein a fixed time slot with an ordinal number is assigned to each communication relation (1-9) between the nodes (10, 20, 30, 40) and the communication relations are performed in the order of the said ordinal numbers,
characterised in that
each time slot (1-4) is assigned a corresponding time slot (6-9) in which transmitter and receiver are exchanged, whereby the assignment of the corresponding time slot (6-9) is carried out in accordance with the principle that in each case the next higher ordinal number for the corresponding time slot (6-9) is assigned to the next lower ordinal number for a time slot (1-4).

8. Wireless interconnected network in accordance with claim 7,
characterised in that
that assignment of the time slots (1-4) and corresponding time slots (6-9) is carried out in accordance with the equation
Ordinal number of the corresponding time slot=Number of time slots per time slot period+1−Ordinal number for the time slot
